(19) United States
(12) Patent Application Publication
(10) Pub. No.: US 2008/0229233 A1
(43) Pub. Date: Sep. 18, 2008

(54) PUSHED FUNCTIONALITY

(75) Inventor: PATRICK D. BLATTNER, Marina Del Rey, CA (US)

Correspondence Address: FISH & RICHARDSON P.C., P.O. BOX 1022, MINNEAPOLIS, MN, 55440-1022, US

(73) Assignee: AOL LLC, Dulles, VA (US)

(21) Appl. No.: 11/780,599

(22) Filed: Jul. 20, 2007

Related U.S. Application Data
(60) Provisional application No. 60/894,969, filed on Mar. 15, 2007.

(51) Int. Cl. G06F 3/048

(52) U.S. Cl. 715/781

(57) ABSTRACT

Delivering accessory-window content to a client includes sending Internet content and accessory-window content to a client. The accessory-window content is configured to enable rendering of the accessory-window concurrent with a window used to display the Internet content, and monitoring user activity outside of the rendered accessory-window for specific activities or situations by a process related to the accessory-window. The accessory-window content is also configured to enable activating an accessory-window trigger in response to detecting one or more of the specific activities or situations, and sending an indication that the accessory-window trigger has been activated to the host. The method also includes receiving an indication that the accessory-window trigger has been activated from the client, and determining content for an accessory-window response based on the received indication. The method further includes retrieving the determined content for the accessory-window response, and sending data associated with the retrieved content to the client. The data enables the client to add, remove, or change content within the rendered accessory-window.

### CROSS-REFERENCE TO RELATED APPLICATIONS

This application is a continuation application of U.S. Provisional Application Serial No. 60/894,969, filed Mar. 15, 2007 and titled “Pushed Functionality,” now pending, which is incorporated by reference in its entirety.

### TECHNICAL FIELD

This document relates to accessory-windows which respond to conditional behavior.

### BACKGROUND

In order to convey information and advertisements, a graphical user interface (GUI) may be configured to display multiple windows concurrently or sequentially in response to a single selection by a web browsing user. For example, navigating to a website may result in the rendering of a first window corresponding to the destination selected by the web browsing user (“the intended destination”) and a second window behind the rendered first window (e.g., a “pop-under” rendering). Also, clicking an Internet link to an intended destination may cause the web browser to render a website other than the intended destination and in substitution for the intended destination for a temporary period of time (e.g., an “interstitial” advertisement).

### SUMMARY

In one general aspect a method of delivering accessory-window content to a client includes sending Internet content and accessory-window content to a client. The accessory-window content is configured to enable rendering of the accessory-window concurrent with a window used to display the Internet content, and monitoring user activity outside of the rendered accessory-window for specific activities or situations by a process related to the accessory-window. The accessory-window content is also configured to enable activating an accessory-window trigger in response to detecting one or more of the specific activities or situations, and sending an indication that the accessory-window trigger has been activated to the host. The method also includes receiving an indication that the accessory-window trigger has been activated from the client, and determining content for an accessory-window response based on the received indication. The method further includes retrieving the determined content for the accessory-window response, and sending data associated with the retrieved content to the client. The data enables the client to add, remove, or change content within the rendered accessory-window.

Implementations may include one or more additional features. For instance, sending accessory-window content may include sending accessory-window content configured to enable the accessory-window to be rendered upon receipt of data from the host that is associated with the retrieved content. Sending accessory-window content may also include sending accessory-window content configured to enable a process to run at the client before the accessory-window is rendered, where the process is configured to monitor user activity outside of the rendered accessory-window for specific activities or situations. Sending accessory-window content may further include sending accessory-window content configured to enable the accessory-window to be rendered before the monitoring the user activity.

Sending Internet content and accessory-window content may include sending the Internet content and the accessory-window content separately. Sending the accessory-window content separately may include sending a ready-to-run file of executable code configured to enable rendering of the accessory-window and sending of the indication that the accessory-window trigger has been activated. Also, sending the accessory-window content separately may include sending the Internet content from a first server at the host and sending the accessory-window content from a second server at the host. The first server may be configured to send requested Internet content to a plurality of clients, and the second server may be configured to send accessory-window and receive indications that accessory-window triggers have been activated from a plurality of clients. Further, sending accessory-window content may include sending a request for instructions for accessing locally available content.

In the method, receiving the indication that the accessory-window trigger has been activated may include receiving a unique identifier which identifies the type of trigger activated or the context of the trigger activation. Receiving the indication that the accessory-window trigger has been activated may include receiving an indication that user has interacted with a rendered piece of content. Receiving an indication that user has interacted with a rendered piece of content may also include receiving text input by a user. Also, receiving the indication that the accessory-window trigger has been activated may include receiving an indication that the client has activated an accessory-window trigger and receiving an indication of media content that is locally available at the client for use in an addition or change to the rendered content of the accessory-window.

Also, in the method, retrieving the determined content for the accessory-window response may include retrieving media data over the Internet. Retrieving the determined content for the accessory-window response may also include conducting an Internet search with text input by a user. Retrieving the determined content for the accessory-window response may further include determining instructions to enable the client to access locally available content.

Further, sending data enabling the client to add, remove, or change content within the rendered accessory-window may include sending data configured to enable the client to monitor for one or more different activities outside of the rendered accessory-window, or for one or more different specific activities or situations.

In another general aspect, a method of effecting an accessory-window with a main window includes receiving information enabling population of Internet content within a main window from a host and rendering the main window. The method includes receiving information enabling population of content within an accessory-window distinct from the main window from the host. The information enabling population of the accessory-window includes information enabling rendering of the accessory-window concurrent to the main window, and information enabling monitoring of user interaction with the main window for an occurrence of one or more activities or situational states by a process related to the accessory-window. The information enabling population of the accessory-window also includes information enabling an addition, update, or deletion to content within the accessory-window. The method includes rendering the accessory-window concurrent with the main window, and monitoring interaction with the main window for an occurrence of the one or more activities or situational states. The method further includes determining that one or more of the activities or situational states have occurred, and adding or updating the content of the rendered accessory-window based on the determination.

Implementations may include one or more additional features. For instance, receiving information enabling monitoring of interaction with the main window for an occurrence of one or more activities or situational states may include receiving information enabling monitoring of interaction with the main window for an occurrence of one or more activities or situational states while the accessory-window is rendered. Also, receiving information enabling monitoring of interaction with the main window for an occurrence of one or more activities or situational states may include receiving information enabling monitoring while the accessory-window is not rendered of interaction with the main window for an occurrence of one or more activities or situational states. Receiving information enabling an addition, update, or deletion to content within the accessory-window may include receiving information enabling initial population of the accessory-window. Also, receiving information enabling an addition, update, or deletion to content within the accessory-window may include receiving information enabling an addition, update, or deletion of content to an existing populated accessory-window, or closing of an existing populated accessory-window.

In the method, rendering the accessory-window concurrent with the main window may include rendering the accessory-window on a portion of a graphical user interface (GUI) that is distinct from the portion of the GUI used to render the main window. Rendering the accessory-window concurrent with the main window may include rendering the accessory-window using a process that is distinct from the process used to render the main window. Also, rendering the accessory-window concurrent with the main window may include rendering the accessory-window on a portion of the GUI that is within the portion of the GUI used to render the main window. Further, rendering the accessory-window concurrent with the main window may include rendering the accessory-window with a position on a GUI that is maintained constant relative to a position on the GUI of the main window. Rendering the accessory-window with the position on the GUI that is maintained constant relative to a position of the main window may include enabling movement of the main window to effect the position of the accessory-window such that the accessory-window maintains the constant relative position. Enabling movement of the main window to effect the position of the accessory-window such that the accessory-window maintains the constant relative position may include associating one or more specific pixels of the main window with the accessory-window.

The method may also include sending an indication to the host that the accessory-window trigger has been activated, and receiving data enabling the addition, removal, or change of content within the accessory-window from the host.

Further, in the method, monitoring interaction with the main window may include monitoring a user's activity. Monitoring a user's activity may include monitoring for interaction with one of several elements displayed within the main window, monitoring for a lack of interaction with rendered potions of the main window, or monitoring for a number or frequency of interactions with rendered potions of the main window. Updating the content of the rendered accessory-window may include rendering interactive content enabling user input. Updating the content of the rendered accessory-window may include changing the shape, size, or location of the accessory-window.

Implementation may include methods, systems, and devices with similar features. Also, implementations of the desired techniques may include hardware or computer software on a computer accessible medium. The details of one or more implementations are set forth in the accompanying drawings and the description below. Other features will be apparent from the description and drawings, and the claims.

### DESCRIPTION OF DRAWINGS

FIG. 1 is a block diagram of an exemplary system configured to enable generation of accessory-windows.

FIG. 2 is a block diagram of an exemplary system configured to enable communication between a client, a host, and Internet content sources to generate or configure accessory-windows.

FIG. 3 is a block diagram of an Internet Service Provider configured to provide accessory-windows.

FIGS. 4A-4D are graphical user-interfaces, each illustrating a common main window and each concurrently illustrating an accessory-window within a main window after user input.

FIGS. 5A-5C are graphical user-interfaces, each illustrating a common main window and each concurrently illustrating an accessory-window corresponding to the common main window after user input.

FIG. 6 is a flow diagram of an exemplary method that leverages a host to generate an accessory-window response.

FIG. 7 is a flow diagram of an exemplary method that leverages host-based accessory-window server to generate an accessory-window response.

FIG. 8A-8B is a flow diagram of an exemplary method that leverages client-based accessory-window software and a host to generate an accessory-window response.

FIG. 9 is a flow diagram of an exemplary method that leverages client-based accessory-window software to generate an accessory-window response.

FIG. 10 is a flow diagram of an exemplary method that leverages a host to enable accessory-window software to be rendered at a client.

FIG. 11 is a flow diagram of delivering accessory-window content to a client.

FIG. 12 is a flow diagram of effecting an accessory-window with a main window.

### DETAILED DESCRIPTION

Pop-up or other accessory-windows are sometimes used to portray supplemental information or links made available, for instance, through a web browser. Accessory-windows are generally used to display content that is locally stored, retrieved from a remote location, or retrieved from a website.

Accessory-windows may be generated by opening an additional viewing area such as a new window, tab, screen, or portion on a user inter-face. They typically are inspired by triggers related to user activity. For example, generation or closure of an accessory-window may be inspired by user entry or exit from a website. In addition, user behavior other than browsing activities may inspire generation or removal of accessory-windows. Specifically, accessory-windows may be generated or removed in response to detection of a user interacting with an electronic asset (e.g., opening, accessing, inputting to, or closing a webpage or other electronic document or program), or when a user neglects to interact with such assets. For example, if a user spends an inordinate amount of time answering a question prompted by a website, an accessory-window that displays helpful instructions may be triggered. Similarly, an accessory-window used to display such a helpful instruction may be updated or closed upon user entry of an answer in the website, avoiding the need for manual interaction with the accessory-window used to display the helpful instruction.

The content of an accessory-window may be determined or updated based on predetermined triggers. Specifically, a website or other content may include a trigger that, when activated, makes a determination of appropriate accessory-window content based on a set of rules. For example, in one implementation, when a user shopping at an online music store browses away from a purchase, a trigger is activated which determines whether the user has often repeated the activity of browsing without completing a purchase. If the number of times that the user has repeated the activity is below a threshold value, the trigger generates an accessory-window with an appropriate guide. If the number of times that the user has repeated the activity is above a threshold value, the trigger generates an accessory-window with a coupon. The determination of appropriate accessory-window content based on a set of rules may be conducted by accessing information at a remote site, rather than a cookie stored locally at the user. Triggers also may update the content of a pre-existing accessory-window.

In another example, a host such as an Internet Service Provider (ISP) may provide accessory-windows rendered collectively with a main window. Specifically, assuming that a user first requests a website of a search engine, the host responsively sends the content of the requested website along with an accessory-window to be rendered within or atop the main window used to display the requested website. The accessory-window includes an input field associated with a trigger that may be used, for example, as an alternative to the content of the requested webpage. When the user enters input (e.g., a search query string) to the input field, the input activates the trigger, which sends information to the host. In response, the host sends back a response to be rendered in the accessory-window. Thus, the user may initiate a host-based search without navigating through successive websites or uniform resource locators (URLs).

In a further example, an accessory-window may monitor indirect user feedback or activities to direct the accessory-windows content and updates. A website may include an accessory-window trigger that prompts generation of the accessory-window in response to a user's inability to complete a task or provide a correct answer. In particular, if a user answers a question incorrectly on the main window, the action may trigger an update of information in an accessory-window responsive to the proffered incorrect answer. If the user then selects the correct answer, a trigger is activated to effect updating of the accessory-window accordingly, (e.g., to read “congratulations”). Using the accessory-windows in this manner enables a host to incorporate helpful content without requiring the user manually navigate through successive websites to receive the content.

Depending on the desired functionality, various software may be used to generate the accessory-window at the client. For example, accessory-windows may be generated and controlled in a separate browser window by imbedding JavaScript® in a website. The JavaScript® code may include triggers to generate, remove, or update content within the separate browser window conditioned upon monitored user activity. In another example vector-based code may be used to generate a ready-to-use file (e.g., an executable file) with instructions for triggers inside. The ready-to-use file is sent to the client, and, when processed, creates an accessory-window within an existing browser window. The accessory-window may include interactive content that results in the accessory-window communicating with a third-party for additional information.

The triggers may be configured to activate various responses. For example, the triggers may load a new website within the accessory-window. The new website may be displayed in a portion or may replace the previous accessory-window. The triggers may also specify a retrieval of information, such as text to be rendered in a text block or multimedia to be rendered. The retrieval of information may include communication with a host or third party.

The aforementioned are merely examples of monitored user behavior or customizable attributes of accessory-windows, and various implementations may include other or differing traits. For example, accessory-windows may monitor and may base triggers upon activities such as, activity levels of a user of a specific window or group of windows, interaction of a user with specific content in a window, input of user inside a window, navigation of a user to or between websites, or other interaction with Internet software. Examples of attributes that may be affected by trigger activation of accessory-windows includes size or position of a separate browser window, size or position of a window rendered within a main window of a website, delay before rendering or ending rendering of a window, content within the window, or updating of content within the window.

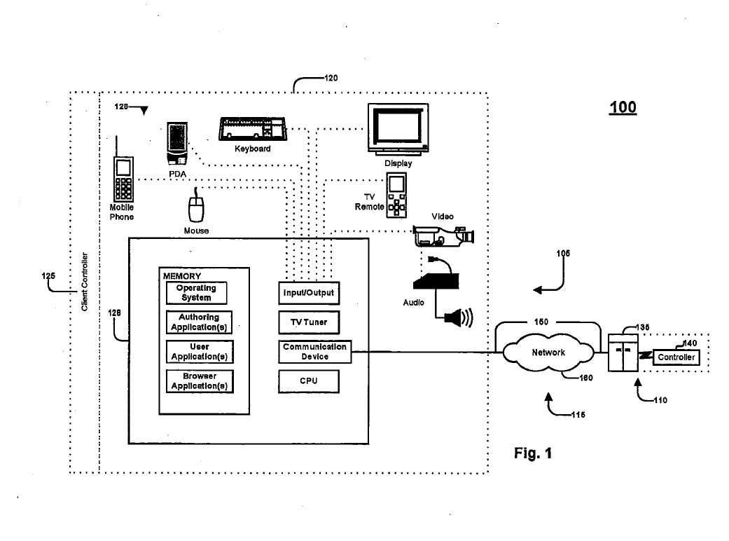

FIG. 1 illustrates a communications system 100 to generate accessory-windows including a first communication participant system 105 communicating with a host system 110 through a communications link 115. The first communications participant system 105 typically includes one or more user devices 120 and/or user controllers 125, and the host system 110 typically includes one or more host devices 135 and/or host controllers 140. For example, the first communications participant system 105 or the host system 110 may include one or more general-purpose computers (e.g., personal computers), one or more special-purpose computers (e.g., devices specifically programmed to communicate with each other and/or the first communications participant system 105 or the host system 110), or a combination of one or more general-purpose computers and one or more special-purpose computers. The first communications participant system 105 and the host system 110 may be arranged to operate within or in concert with one or more other systems, such as, for example, one or more LANs (“Local Area Networks”) and/or one or more WANs (“Wide Area Networks”).

The user device 120 and the host device 135 are generally capable of executing instructions under the command of, respectively, the user controller 125 and the host controller 140. The user device 120 and the host device 135 are connected to, respectively, the user controller 125 and the host controller 140 by, respectively, wired or wireless data pathways 130 and 145, which are capable of delivering data.

The user device 120, the user controller 125, the host device 135, and the host controller 140 typically each include one or more hardware components and/or software components. An example of a user device 120 or a host device 135 is a general-purpose computer (e.g., a personal computer) or software on such a computer capable of responding to and executing instructions in a defined manner. Other examples include a special-purpose computer, a workstation, a server, a device, a component, other physical or virtual equipment or some combination of these capable of responding to and executing instructions. The user device 120 and the host device 135 may include devices that are capable of establishing peer-to-peer communications.

An example of user controller 125 or host controller 140 is a software application loaded on the user device 120 or the host device 135 for commanding and directing communications enabled by the user device 120 or the host device 135. Other examples include a program, a piece of code, an instruction, a device, a computer, a computer system, or a combination of these for independently or collectively instructing the user device 120 or the host device 135 to interact and operate as described. The user controller 125 and the host controller 140 may be embodied permanently or temporarily in any type of machine, component, physical or virtual equipment, or storage medium capable of providing instructions to the user device 120 and the host device 135.

The communications link 115 typically includes a delivery network 160 that provides direct or indirect communication between the first communications participant system 105 and the host system 110, irrespective of physical separation. Examples of a delivery network 160 include the Internet, the World Wide Web, WANs, LANs, analog or digital wired and wireless telephone networks (e.g., Public Switched Telephone Network (PSTN), Integrated Services Digital Network (ISDN), and a type of Digital Subscriber Line (DSL)), radio, television, cable, or satellite systems, and other delivery mechanisms for carrying data. The communications link 115 may include communication pathways 150 and 155 that enable communications through the one or more delivery networks 160 described above. Each of the communication pathways 150 and 155 may include, for example, a wired, wireless, cable or satellite communication pathway.

The first communication participant system 105 includes a user device that typically includes a general-purpose computer 128 having an internal or external memory for storing data and programs such as an operating system (e.g., Windows Vista™, Linux, etc.) and one or more application programs. Examples of application programs include authoring applications (e.g., word processing programs, database programs, spreadsheet programs, or graphics programs) capable of generating documents or other electronic content; user applications (e.g., America Online (AOL) client, AOL Instant Messenger (AIM) client, interactive television (ITV) client, ISP client, communication client or personal communications (IM) client) capable of communicating with other computer 128 users, accessing various computer 128 resources, and viewing, creating, or otherwise manipulating electronic content; and browser applications (e.g., Netscape's Navigator or Microsoft's Internet Explorer) capable of rendering standard Internet content and other content formatted according to standard protocols such as the Hypertext Transfer Protocol (HTTP). The programs may be configured to receive data over the Internet which includes triggers for accessory-windows. When activated, received triggers may direct a program to receive further data used to generate or configure an accessory-window.

One or more of the application programs may be installed on the internal or external storage of the general-purpose computer 128. Alternatively, in another implementation, the user controller 125 may access application programs externally stored in and/or performed by one or more device(s) external to the general-purpose computer 128.

The general-purpose computer 128 also includes a central processing unit (CPU) for executing instructions in response to commands from the user controller 125, and a communication device for sending and receiving data. One example of the communication device is a modem. Other examples include a transceiver, a set-top box, a communication card, a satellite dish, an antenna, a network adapter, or some other mechanism capable of transmitting and receiving data over the communications link 115 through a wired or wireless data pathway 150. The general-purpose computer 128 optionally includes a television (“TV”) tuner for receiving television programming in the form of broadcast, satellite, and/or cable TV signals. The TV tuner permits the user device 120 to selectively and/or simultaneously display network content received by communications device and TV programming content received by the TV tuner.

The general-purpose computer 128 may include an input/output interface that enables wired or wireless connection to various peripheral devices 126. Examples of peripheral devices 126 include, but are not limited to, a mouse, a mobile phone, a personal digital assistant (PDA), an MP3 player (not shown), a keyboard, a display monitor with or without a touch screen input, a TV remote control for receiving information from and rendering information to users, and an audio-visual input device.

Although FIG. 1 illustrates devices such as a mobile telephone, a PDA, and a TV remote control as being peripheral with respect to the general-purpose computer 128, in another implementation, such devices may themselves include the functionality of the general-purpose computer 128 and operate as the user device 120. For example, the mobile phone or the PDA may include computing and networking capabilities and function as a user device 120 by accessing the delivery network 160 and communicating with the host system 110. Furthermore, the first communication participant system 105 may include one, some or all of the components and devices described above.

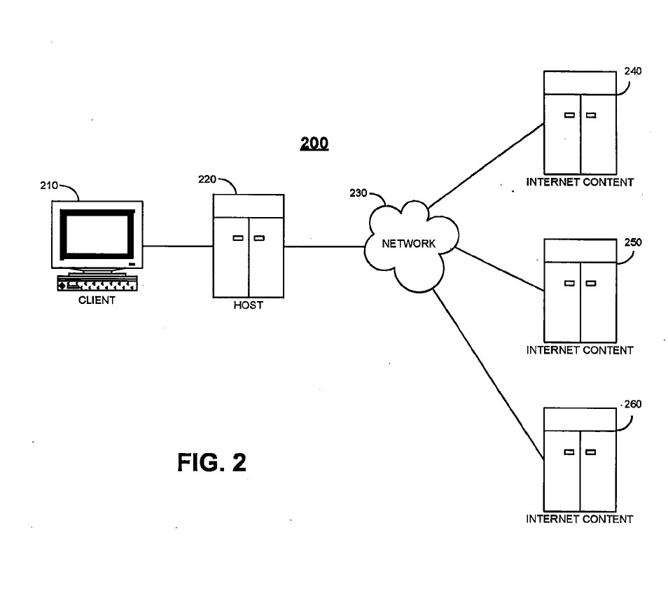

Referring to FIG. 2, a system 200 is configured to communicate with a host 220 and Internet content 240-260 to generate or configure accessory-windows. System 200 includes a client 210, the host 220, a network 230, and the Internet content 240-260.

Each of the client 210, the host 220, and the Internet content 240-260 may be implemented by, for example, the first communication participant system 105, described with respect to FIG. 1. The client 210 may include one or more devices capable of accessing content from the host 220. More particularly, the client 210 may be configured to access the Internet content 240-260 directly, or through the host 220. Accessing the Internet content 240-260 may include accessing a web page with a URL, downloading files, software, or accessing other types of information. The client 210 may send access requests directly to the Internet content 240-260, through the network 230, through the host 220, or through the host 220 and the network 230.

The host 220 may include a collection of servers configured to distribute tasks, processing, or bandwidth. The host 220 may be configured to receive information requests for Internet content from the client 210 and to request Internet content from the Internet content 240-260. The client 210 or host 220 may be configured to receive Internet content 240-260 over the network 230 which includes triggers for accessory-windows. When activated, received triggers may direct a program to receive further data used to generate or configure an accessory-window.

The network 230 includes hardware and/or software capable of enabling direct or indirect communications between the client 210, the host 220, and the Internet content 240-260. As such, the network 230 may include a direct link between the client 210 and the host 220, and the host 220 and the Internet content 240-260, or they may include one or more networks or sub networks between them (not shown). Each network or sub network may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

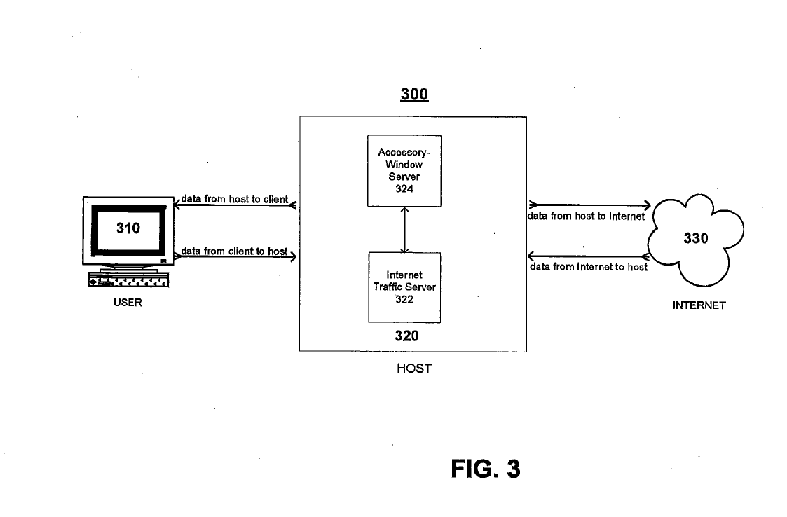

Referring to FIG. 3, a host 320 is configured to provide accessory-windows including information retrieved over the Internet 330 to a user 310. In the system 300 the user 310 connects to the host 320 in order to gain access to the Internet 330. The host 320 may be the same host 220 as discussed with respect to FIG. 2.

The host 320 directs the communication of Internet traffic and is configured to generate and control triggers and accessory-windows. In one implementation, the host 320 generates and configures triggers and accessory-windows independent of webpages retrieved from the Internet 330. Specifically, as the user interacts with the host 320 and the host's client software, triggers may be activated to generate and/or configure an accessory-window. In another implementation, the host 320 generates and configures accessory-windows that include content retrieved over the Internet 330. The content may be retrieved before or after the delivery or activation of the trigger at the client.

The host 320 includes an Internet traffic server 322 and an accessory-window server 324. The Internet traffic server 322 is configured to direct the retrieval of Internet-based information sent to the client. For example, when a user 310 requests a website over the Internet 330, the Internet traffic server 322 directs the appropriate webpage to the user 310. The accessory-window server 324 communicates with the Internet traffic server 322 to distribute accessory-window content to the user 310 and receive communications from the user 310 regarding accessory-windows (e.g., an indication a trigger has been activated). The accessory-window content may be distributed with a website from the Internet traffic server 322, or may be sent separately. For example, in one implementation, the accessory-window content is used to generate a file of ready-to-run code which is configured to render an accessory-window over requested Internet content. The file of ready-to-run code may be sent to the client from the accessory-window server 324 or may be sent to the Internet traffic server 322 and then delivered along with the requested content to the user 310.

The accessory-window may include various triggers that, when activated, may send an indication to the accessory-window server 324. After receiving an indication, the accessory-window server 324 may determine the appropriate course of action, such as, creating or deleting an accessory-window, updating content within an accessory-window, changing appearance or position of an accessory-window, or retrieving Internet information to use with an accessory-window.

The previous description provides an exemplary implementation of an ISP configured to provide accessory-windows. Other implementations may include other or different features. For instance, the accessory-window server may be an application, or module within an application, in the Internet traffic server. Also, in various implementations, the accessory-window server is included within software stored locally at the user (e.g., the ISP's client-software).

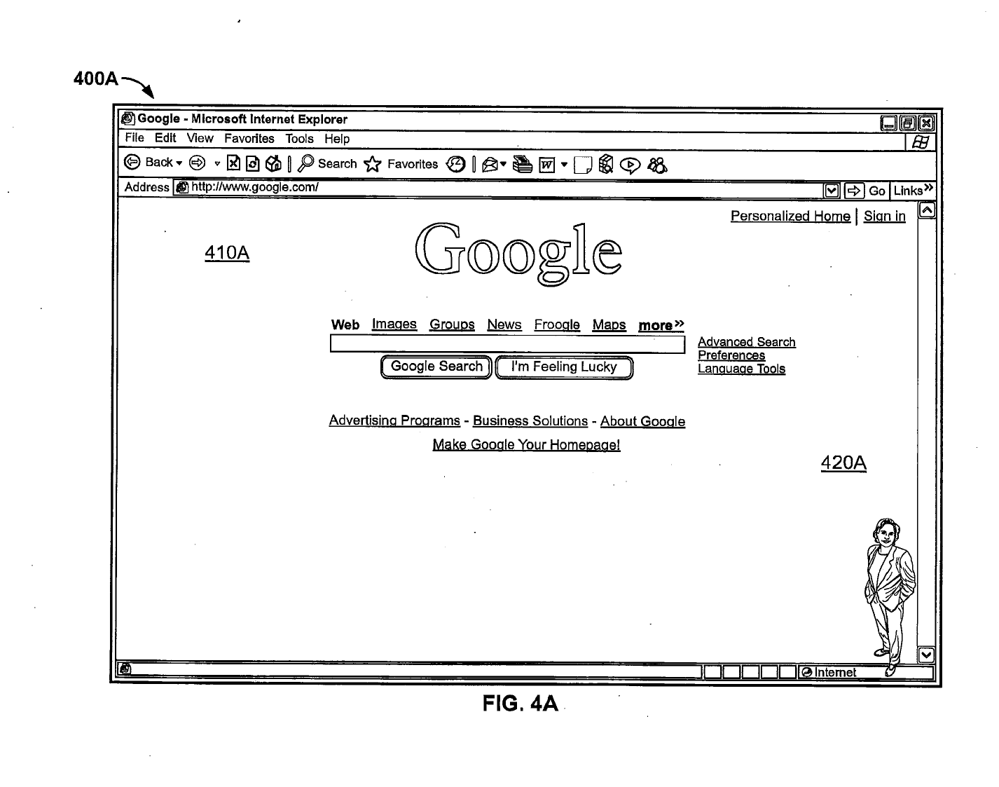

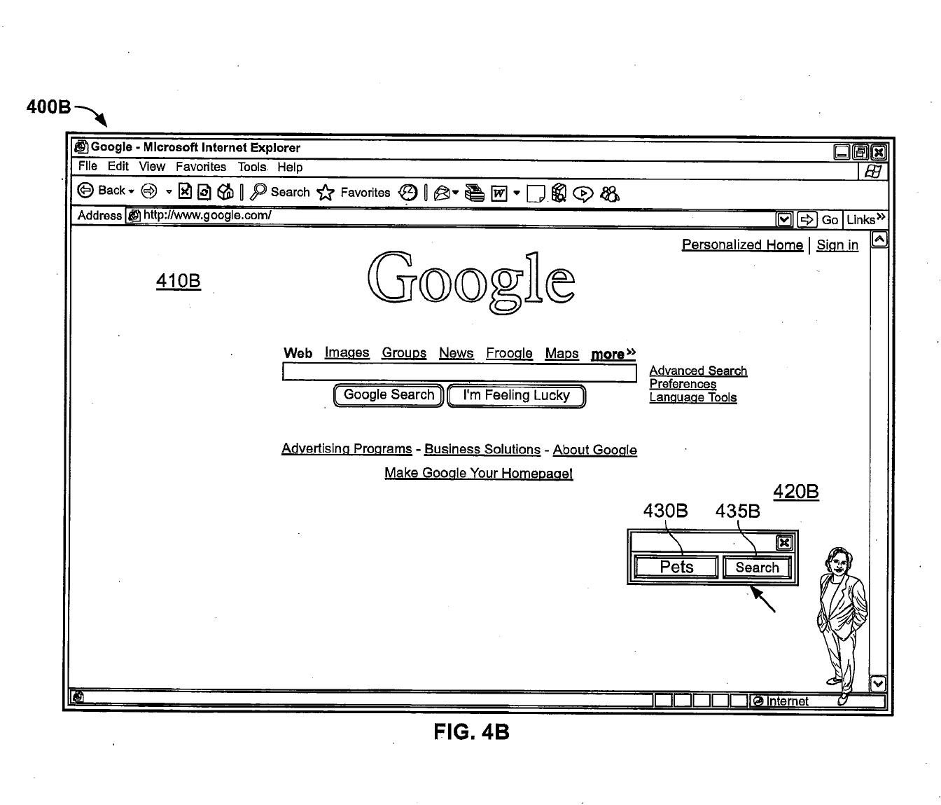

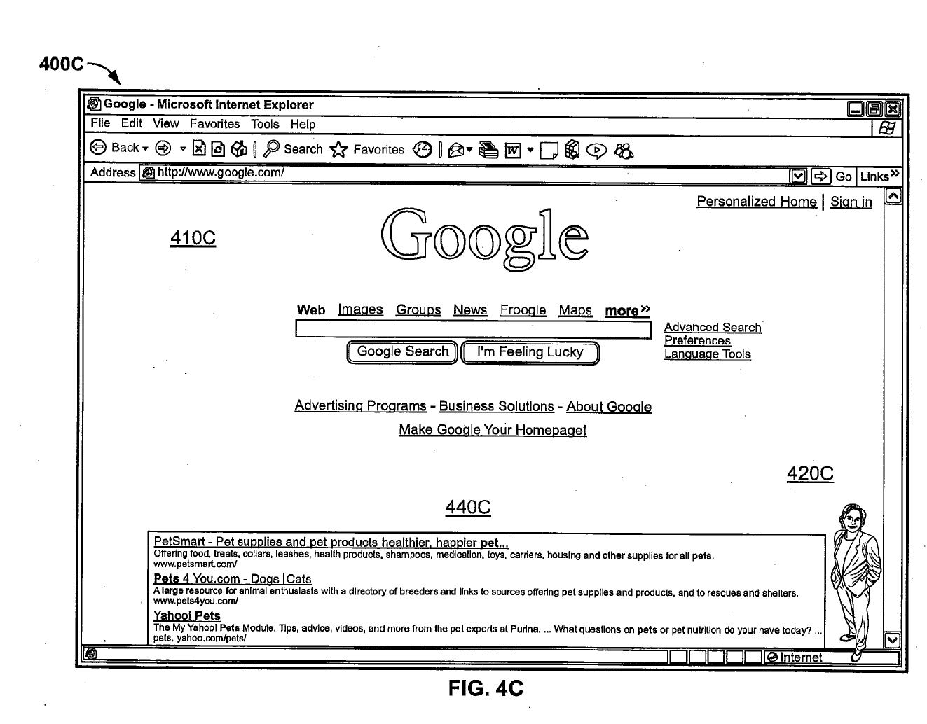

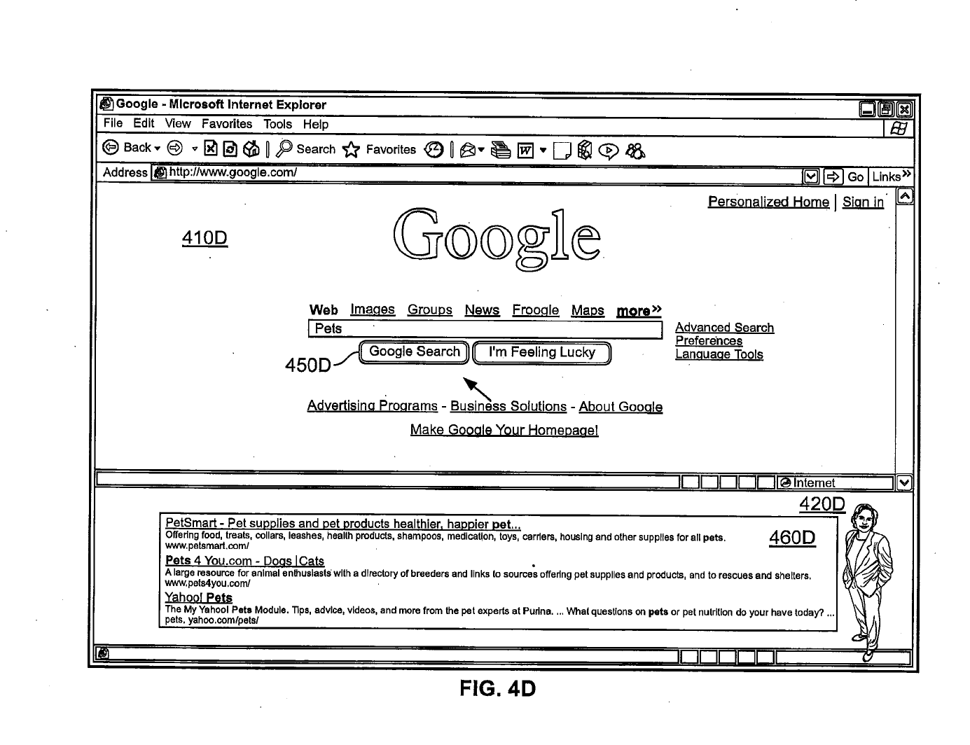

Referring to FIGS. 4A-4D, various versions of a GUI 400A-400D are illustrated. As shown in FIG. 4A, GUI 400A includes an accessory-window 420A within a web browser interface main window 410A. In the GUI 400A-400D, a user has navigated the web browser to a search engine. When loading the search engine within the main window 410A, an accessory-window 420A also has been loaded. The accessory-window 420A-420D is rendered concurrent with, and within and/or on top of, the main window 410A-410D. In one implementation, M-Projector® and Flash® are used to generate an executable program, loaded at the client, which renders the accessory-window 420A-420D over an active window or a portion of an active window. The accessory-window 420A-420D may be configured to be tied (or otherwise positioned relative) to specific pixels associated with (or objects appearing within) the active window.

Referring to FIG. 4A, the navigation to the website initiates rendering of the accessory-window 420A on top of the main window 410A. In one implementation, the user's request for the website prompts the host to deliver a ready-to-run file that is automatically processed to generate the accessory-window 420A. The accessory-window 420A includes a multimedia presentation (in FIG. 4A, a video of a woman speaking instructions) that is rendered as above the main window. The multimedia presentation will move along with movement of the main window 410A and remain in the same location relative to the main window 410A. The multimedia presentation is interactive and may respond to certain input or activities by the user. The data corresponding to the multimedia content 440 may be included within the ready-to-run file, stored locally, downloaded, or streamed as needed.

Referring to FIG. 4B, the user has clicked on the accessory-window 420A, which in turn causes the accessory-window 420B to display an input field 430B. In one implementation, the accessory-window's initial instructions (e.g., the ready-to-run file) includes instructions to render an input field when the user clicks the accessory-window. In another implementation, when the user clicks on the accessory-window 420B, a trigger is activated, and an indication of the input is sent to the host. The host, in response, sends instructions to generate the input field 430B.

When text is added to the input field 430B, and the search icon 435B is clicked, a trigger is activated. The trigger causes the client to send an indication of the input text to the host. The host then conducts a search to determine an appropriate response for the input text. The appropriate response (in this case, search results) is sent to the client. The client receives the instructions and updates the rendered content.

FIG. 4C assumes that the user has typed the word “Pets” into the input field 430B of FIG. 4B and clicked the search icon 435B. In response, the client has sent an indication of the input “Pets” to the host, and the host has sent updated content to the user. The updated content is rendered 440C by updating the accessory-window.

FIG. 4D illustrates an implementation for providing content with an accessory-window through monitoring of activity outside of the accessory-window. FIG. 4D assumes that the user has typed the word “Pets” into the input field 450D of the main window 410D. In response, the client has sent an indication of the input “Pets” to the host, and the host has sent content to the user. The indication may be sent in response to the input of the letters, or may be sent in response to the entering of the search. The content is received and rendered 460D using an accessory-window 420D. The accessory-window 420D is located outside of, but may overlap with, the main window 410D.

The previous description provides an exemplary implementation involving a GUI including an accessory-window within a main window. Other implementations may include other or different features. For instance, the accessory-window may be programmed with additional interactive content or triggers, to, for example, enable further searching or other activities or updates.

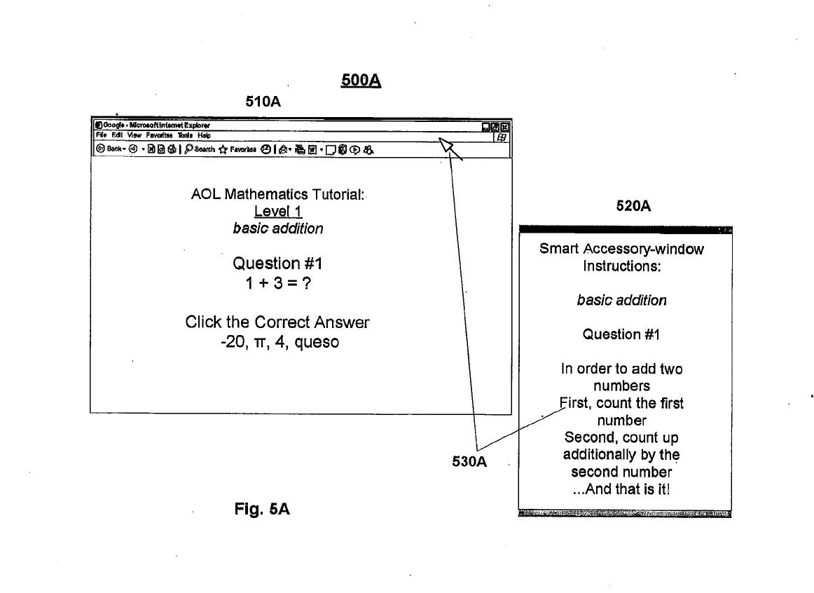

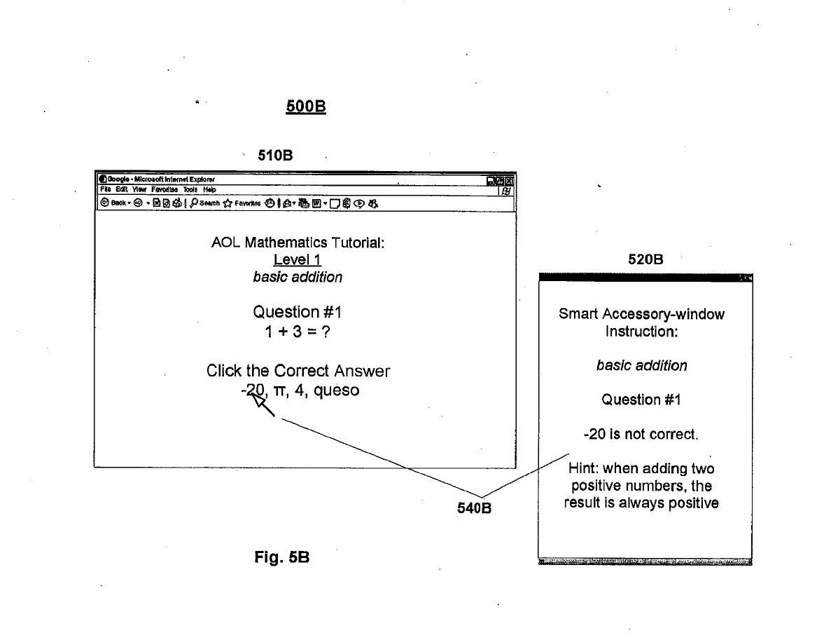

Referring to FIGS. 5A-5C, GUIs 500A-500C each include a main window 510A-510C and an accessory-window 520A-520C. The GUI 500A-500C is rendered to a user accessing a webpage (shown in main window 510A-510C) which includes triggers that inspire an accessory-window (shown at accessory-window 520A-520C). In contrast to the accessory-window 420A-420C discussed, with respect to FIGS. 4A-4D, the accessory-window 520A-520C is a web browser window and/or browser instance (e.g., active browser code or “process” in memory) separate from the main window 510A-510C. As demonstrated by FIGS. 4A-4D and 5A-5C, the accessory-window may be rendered by an active process that is associated with the browser window of the main window or with a separate browser window. The triggers to render and control the accessory-windows may be located locally at the user, or remotely. In one implementation, the instructions and triggers are Javascript™ based software within the hyper text markup language (HTML) of the webpage.

Referring to FIG. 5A, the main window 510A of GUI 500A corresponds to a (fictitious) website www.crazyaolmath.com. The user loads the webpage 530A shown in the main window 510A, and concurrently loads the accessory-window 520A through the instructions embedded in the HTML. The instruction also include triggers to be used to effect the status of the accessory-window 520A. The triggers may be code configured to monitor for one or more specific activities to activate a specific response. The content of the rendered accessory-window 520A may be stored locally within pre-existing software at the client (e.g., a client ISP's software), stored with the trigger (e.g., embedded within the main webpage's HTML), or retrieved from a source remote from the client at the time of rendering. In this example, the accessory-window 520A provides additional instructions to compliment the user's understanding of the main window 510A. Specifically, in the GUI 510A, clicking each answer in the main window 510B will activate a specific trigger which will update the accessory-window 520B according to the selected answer.

Some pop-up systems embed code associated with hyperlinks that cause new windows to be generated upon the hyperlinks activation. In these systems, the user may not have the option to disable the embedded code. Consequently, users may turn to third party or other software to prevent the effects of the embedded code. In contrast to such embedded code, in one implementation of the example of FIG. 5A, the accessory-window 520A monitors for trigger activation with the process used to render the accessory-window 520A. If the accessory-window 520A is closed by the user, the process ends. The trigger is activated only if the monitored activity occurs as the accessory-window 520A is rendered. Thus, if the user closes the accessory-window 520A before clicking an answer on the main window 510A (which is a trigger), a new or updated accessory-window will not be rendered. Consequently, the user may choose to close the accessory-window 520A in order to interact with the main window without activating triggers.

Referring to FIG. 5B, the accessory-window 520B monitors user activity with specific rendered portions of the main window 510A. In particular, a trigger is activated when a user clicks an incorrect answer 540B in the main window 510A, resulting in an update to the accessory-window 520B. The trigger reconfigures the accessory-window to display new content based on the trigger activation. In the GUI 500B, the activation 540B of the trigger results in an accessory-window 520B update associated with the specific incorrect answer. The update effects the rendered content of the accessory-window 520B, and updates the text to display helpful information in over-coming the specific wrong answer choice.

Referring to FIG. 5C, the accessory-window 520C also monitors user activity with the main window 510C without regard to specific rendered portion. In particular, another trigger is activated 550C when a user fails to click any of the answer choices or otherwise interact with the main window 510C before a timer associated with the main window 510A-510C reaches a threshold of time. The accessory-window 520A-520C includes a timer which monitors user-input for a lack of activity while the main window 510C is active or displayed “on-top” (e.g., the user has the main window rendered and selected, but has not selected an answer choice or is otherwise idle). Once a threshold of time has been reached, the trigger is activated. If the user minimizes the webpage or interacts with unrelated software, the timer may be paused or reset. That is, the absence of user action is detected while the user engages the main window 510C. The trigger updates the accessory-window 520C to display new content that provides helpful information to the user in over-coming the inability to determine the correct answer choice.

The previous description provides an exemplary implementation involving a GUI including a main window and an accessory-window. Other implementations may include other or different features, and the triggers and monitoring of the main window may also be applied to the accessory-window itself. For instance, a further trigger may be included which is activated by selection of the correct answer choice and effects the closing of the accessory-window. Specifically, the accessory-window may monitor user activity for selection of the correct answer to activate a trigger updating the content of the accessory-window. The updated content may be new text (e.g., “correct, congratulations!”) replacing the previous text, or may effect the closing of the accessory-window.

Further, in one implementation, every answer is associated with a different trigger, where each trigger updates content of the accessory-window that is unique to the activated trigger. In other implementations, selection of some or all answers are associated with a single trigger, such that selection of any of the incorrect answer choices activates an incorrect-answer trigger, effecting updating of the content of the accessory-window with new text (e.g., “that is incorrect”) replacing the previous text.

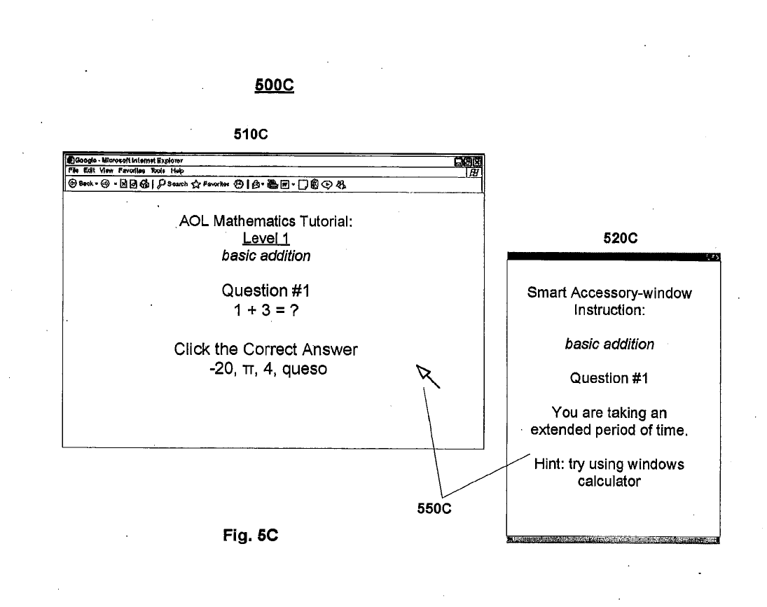

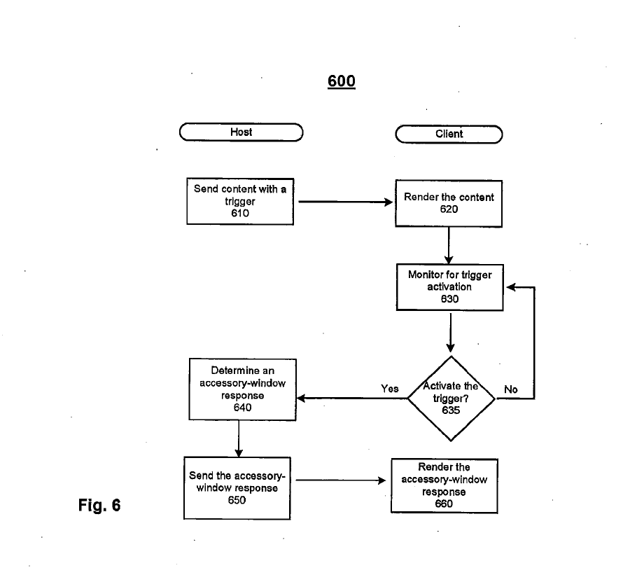

Referring to FIG. 6 a method 600 to generate an accessory-window response is shown. In the method 600, a host directs retrieval of Internet content and accessory-window responses at a client. When the client activates a trigger, the host determines the response.

The method 600 begins when a host sends content with one or more triggers to the client (610). The content may be single-session information, such as a webpage, or multi-session software, such as a locally stored ISP's client software. The triggers may be built into the content or sent separately. The client renders the content (620), and monitors for trigger activation (630). Rendering the content, may include rendering a webpage, a pop-up, a client interface, or other window. In one implementation, the content is data pertaining to a requested website (e.g., HTML). including instructions for triggers that may be activated as the data is used to render the website.

The triggers may be activated based on activity or monitored activity at the client. In particular, the triggers may be configured to be activated by an activity, an amount of activity, or a status of the client. For example, the trigger may be activated by a user at a host clicking on a window or a webpage, web-surfing, entering data, or by a lack of activity. Monitoring for trigger activation (630) may include accessing, at intervals of time, data in computer memory to determine whether the data meets a condition, or may include receiving, at a running process, a notice when the condition is met. For example, a process associated with the accessory-window may review status of another process active in memory, or may receive an indication from the operating system.

When a trigger is activated (635), the client sends an indication of the trigger activation to the host. The indication may be a simple indication, such as data specifying that a trigger has been activated. For example, the simple indication may include a line of code with a value for a variable that indicates whether the trigger has been activated. The indication may also be a detailed indication, such as a request related to web-browsing. For example, the detailed indication may include data, such as text, entered by a user, or information directed to monitored activity at the user.

The host receives the trigger activation and determines a response for the accessory-window (640). The response may be, for example, to delete the window. The response also may be to update or change the content of the accessory-window, or to change its size, position, or appearance. In one implementation, the response includes data enabling a preexisting accessory-window to add interactive content within the window which includes new triggers. The new triggers may update or remove previous triggers associated with the window.

The host sends the accessory-window response to the client (650). The sending of the response may be in the form of an executable file, data related to media, or a command directed to running software to generate or update a window. The client receives the response and renders the accessory-window with the response (660).

The previous description provides an exemplary implementation of a method to generate an accessory-window response. Other implementations may include other or different features. Specifically, in various implementations the client may monitor for trigger activation prior to rendering the content. For example, in one implementation, an activated trigger causes the rendering of the content.

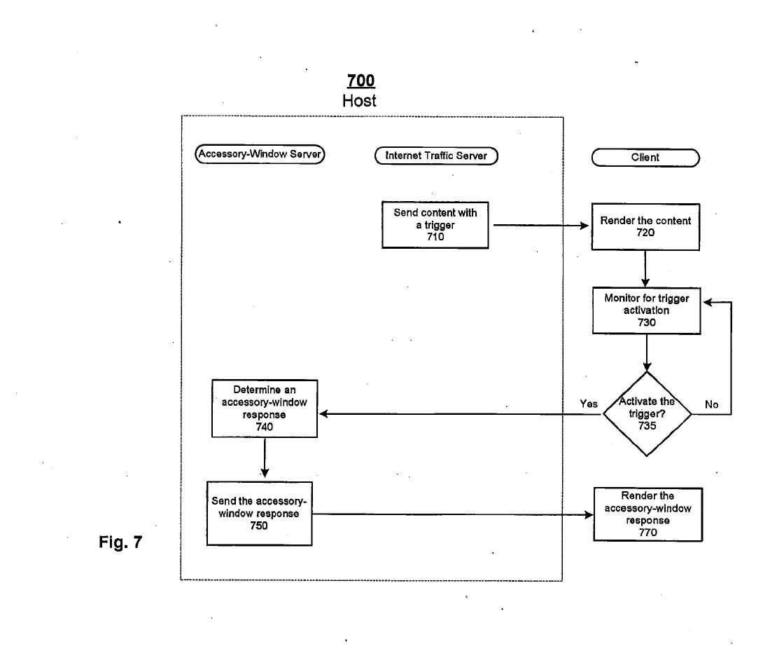

Referring to FIG. 7 a method 700 to use a host-based accessory-window server to generate an accessory-window response is shown. In the method 700, a host-based Internet traffic server directs retrieval of Internet content and a host-based accessory-window server directs retrieval of accessory-window responses at a client. When the client activates a trigger, the accessory-window server determines the response. The Internet traffic server and the accessory-window server may be the servers 322 and 324 described, with respect, to FIG. 3. The method 700 may be particularly useful in implementations where the content and triggers are directed to client software (such as the software used to access an ISP).

The method 700 begins when a Internet traffic server sends content with one or more triggers to the client (710). The client renders the content (720), and monitors for trigger activation (730). When a trigger is activated (735), the client sends an indication of the trigger activation to the accessory-window server. After receiving the indication of the trigger activation, the accessory-window server determines a response for the accessory-window (740). The accessory-window server sends the accessory-window response to the client (750). The client receives the response and renders the accessory-window with the response (760).

The previous description provides an exemplary implementation of a method to use a host-based accessory-window server to generate an accessory-window response at a client. Other implementations may include other or different features. For instance, the client may send the indication that the trigger has been activated to the Internet traffic server, where the indication is forwarded on to the accessory-window server. Further the response determined by the accessory-window server, may be sent to the Internet traffic server, where the response is forwarded on to the client. In various implementations, the Accessory-window server and the Internet traffic server may be different modules or processes within the same server at the host.

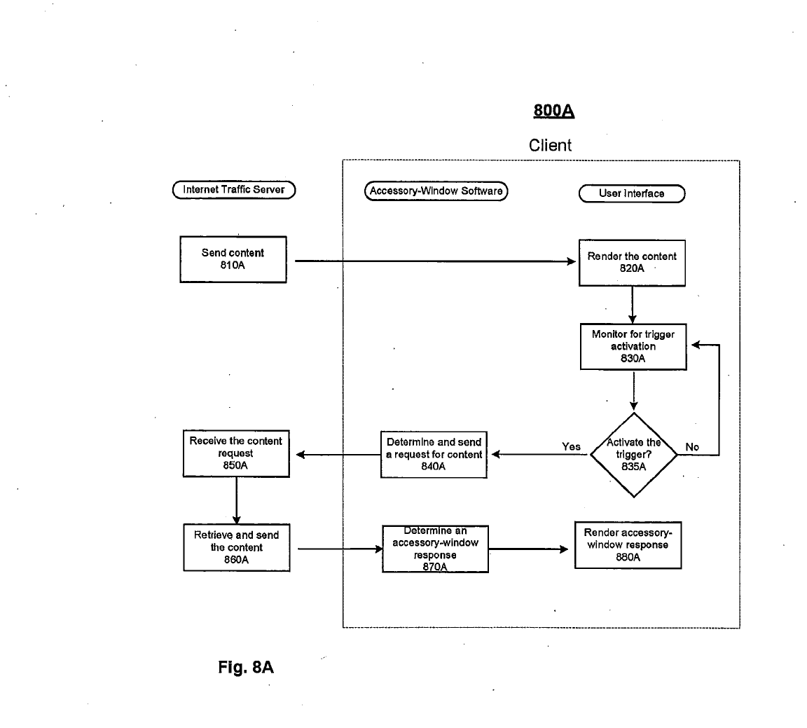

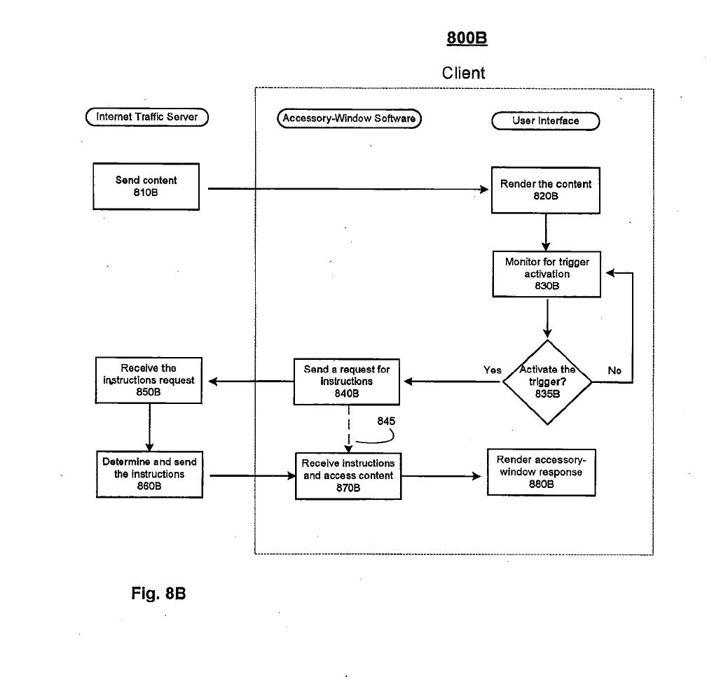

FIGS. 8A-8b illustrate methods 800A-800B to use client-based accessory-window software and a host to generate an accessory-window response. In the method 800A, a host-based Internet traffic server directs retrieval of Internet content and client-based accessory-window software directs retrieval of accessory-window responses at the client. When the client activates a trigger, the accessory-window software at the client determines the appropriate response and obtains, from the Internet traffic server, content to deliver the response. The method 800A may be particularly useful in implementations where the content and triggers are directed to software which is independent of websites or ISPs.

The method 800A begins when a Internet traffic server sends content to the client (810A). The client renders the content (820A), and monitors for trigger activation (830A). When a trigger is activated (835A), the client sends an indication of the trigger activation to the accessory-window software (840A). In one implementation, the content may be any webpage, and the triggers are pre-determined by the accessory-window software.

After receiving the indication of the trigger activation, the accessory-window software determines a request for content (840A). The request may be directed to content that is located remotely. A request for content is generated by the accessory-window software and sent to the Internet traffic server. In one implementation, when user a enters a search in a search engine that is not affiliated with an ISP, the search activates a trigger for an accessory-window in client software. In the implementation, the client software then requests search results from the ISP's search engine through the ISP's Internet traffic server to enable rendering of an accessory-window displaying the search results.

The Internet traffic server receives the request for content (850A) and the requested content is retrieved (860A). If the requested content is stored locally at the server or an associated ISP, the content may be loaded to be sent to the client. If the requested content is not locally stored, the Internet traffic server may retrieve the content from a remote location, such as, a webpage or a file-transfer-protocol server.

Upon receiving the requested content from the Internet traffic server, the accessory-window software determines an accessory-window response (870A). In one implementation, determining an accessory-window response includes simply adding the received content to a response. In various implementations, determining an accessory-window response includes analyzing the received content, and dependent upon the analysis, the content is included in the response. The accessory-window response is rendered (880A). For example, in the search engine example above, if the search results from the ISP's search engine are found to include no pertinent results, the accessory-window software may determine the response to be a notice of no useful results.

In the method 800B, a host-based Internet traffic server directs retrieval of Internet content and provides instruction for the client-based accessory-window software to render an accessory-window response. When the client activates a trigger, the accessory-window software at the client may requests instructions for an appropriate response. The method 800B may be particularly useful in implementations where the content and triggers are directed to software which is independent of websites or ISPs, or where accessory-window responses may be frequently changed.

The method 800B begins when a Internet traffic server sends content to the client (810B). The content may include content to enable rendering of a main window, an accessory-window, and accessory-window responses. The client renders the content (820B), and monitors for trigger activation (830B). When a trigger is activated (835B), the client sends an indication of the trigger activation to the accessory-window software (840B).

After receiving the indication of the trigger activation, the accessory-window sends a requests for instructions to the Internet traffic server (840B). The request for instructions may include a list of locally available content that may be accessed, information detailing the state of the client, information detailing the trigger that was activated, or other information.

The Internet traffic server receives the request for instructions (850B), and determines and sends the appropriate instructions to the accessory-window software (860B). Determining the appropriate instructions may include analyzing the state of the client, the trigger activated, content locally available at the client, or third party servers or information.

Upon receiving the requested instructions from the Internet traffic server, the accessory-window software accesses locally available content for an accessory-window response (870A). The accessory-window response is rendered with the accessed content (880A).

In various implementations, the accessory-window software may first determine if locally available instructions or content enables the appropriate accessory-window response, or if instructions from the host are required. If the locally available instructions are sufficient, or if instruction from the host are not required, the accessory-window software will forgo sending the request for instructions (840B), and move 845 to the step of accessing content (870B).

The previous description provides an exemplary implementation of a method to use client-based accessory-window software and a host to generate an accessory-window response. Other implementations may include other or different features. For instance, the Internet traffic server may send additional content along with the instructions.

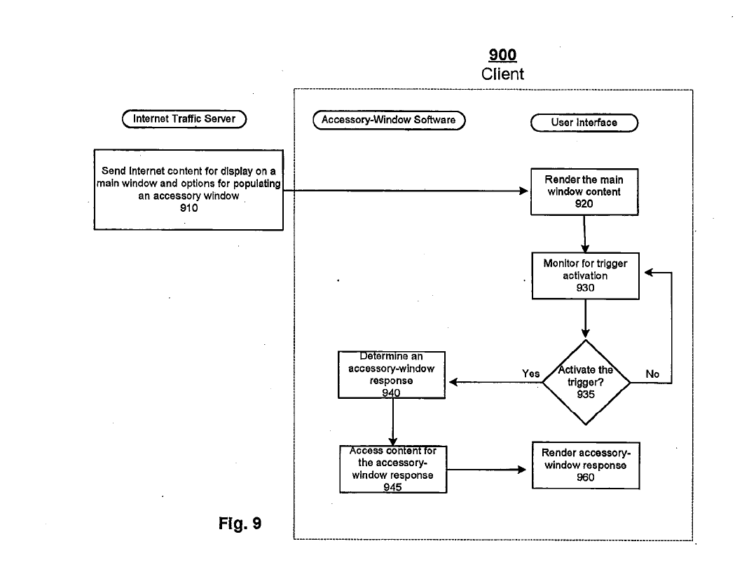

Referring to FIG. 9 a method 900 to use client-based accessory-window software to generate an accessory-window response is shown. In the method 900, a host-based Internet traffic server sends content to a client and client-based accessory-window software directs retrieval of accessory-window responses at the client. When the client activates the trigger to generate an accessory-window, the accessory-window software at the client determines the appropriate response and obtains, locally, needed content to deliver the response. The method 900 may be particularly useful in implementations where the needed content may not be remotely easily obtained on demand (e.g., large video files), or where limited bandwidth is available (e.g., “dial up” or limited Internet connections). For example, the method 900 may be used with portable devices with limited communications when accessing a host.

The method 900 begins when a Internet traffic server sends Internet content for display on a main window and options for populating an accessory-window (910). The content may include content associated with responses to trigger activation. In one implementation, all required content for responses is sent concurrently with the triggers that may result in the responses. The client renders the content (920), and monitors for trigger activation (930). When a trigger is activated (935), the client sends an indication of the trigger activation to the accessory-window software.

After receiving the indication of the trigger activation, the accessory-window software determines a request for content (940). The request may be directed to content that is stored locally. The accessory-window software determines an accessory-window response (950). The accessory-window response is rendered (960).

In various implementations, needed content for accessory-window responses is often large media files (e.g., video files) which are not easily retrieved on-demand from remote sources. The accessory-window software includes needed content. Updates to the needed content are retrieved prior to the accessory-window software determining a request for the content of the update.

The previous description provides an exemplary implementation of a method to use client-based accessory-window software to generate an accessory-window response. Other implementations may include other or different features. For instance, the options for populating an accessory window may be sent prior to the sending of the Internet content, and by entities distinct from the Internet traffic server. For example, in one implementation, a digital video disc is used to load the options for populating an accessory window, including multimedia files, at the client.

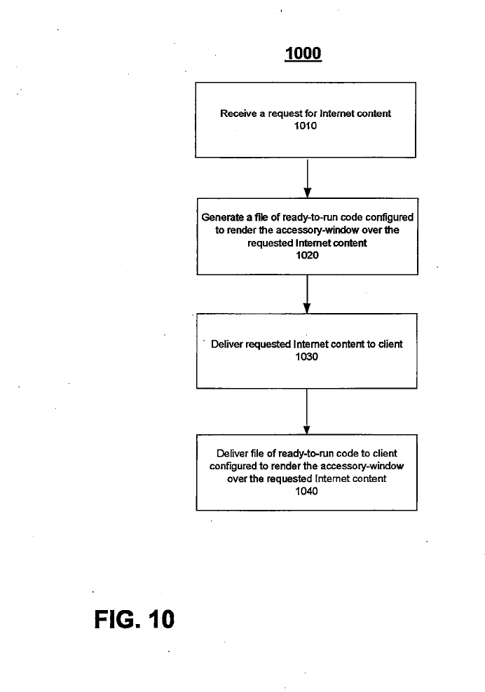

Referring to FIG. 10, a method 1000 to use accessory-window software to generate an accessory-window response is shown. In the method 1000, a host-based Internet traffic server is directing receipt of Internet content, such as websites or ISP specific content. When a client sends a request for content, the request may trigger the host to generate and send a file configured to enable the rendering of an accessory-window with the requested content at the client.

In the method 100, a request for Internet content is received (1010). The request may be for a specific URL or program, or an action, such as, for example, a request for a search and an Internet search engine. The requested may be sent directly from the client to the host, or may be directed at a third party but sent through the host.

A file of ready-to-run code configured to render the accessory-window over the requested Internet content is generated (1020). The file may be, for example, an executable (i.e., “.EXE”) file that may be processed by the operating system of the client. The file also may include vector based coding to generate an accessory-window that is tied to (e.g., configured to always render on-top of) a pixel in another window. In particular, if an accessory-window is tied to a pixel of a main window the accessory-window will move relative to the main window. For example, if a main window is dragged to the left of a portion of a screen, the accessory-window tied to and covering a portion of the main window will also be dragged to the left, and will continue to cover the same portion of the main window.

The requested Internet content is delivered to the client (1030). Separately or along with the delivery of the Internet content, the file of ready-to-run code is delivered to the client (1040). In one implementation, the file of ready-to-run content is embedded as instructions with HTML code of the internet content. In other implementations, the file is sent in a separate transmission.

The previous description uses a host to enable accessory-window software to be rendered at a client. Other implementations may include other or different features. For instance, the host may generate and store a universal ready-to-run file that may be accessed at a later time in response to one of various clients requesting specific Internet content. For example, in one implementation, when a client requests a website, the host or client may load an already existing .exe file, and the host may transmit the loaded file along with the website content to the client.

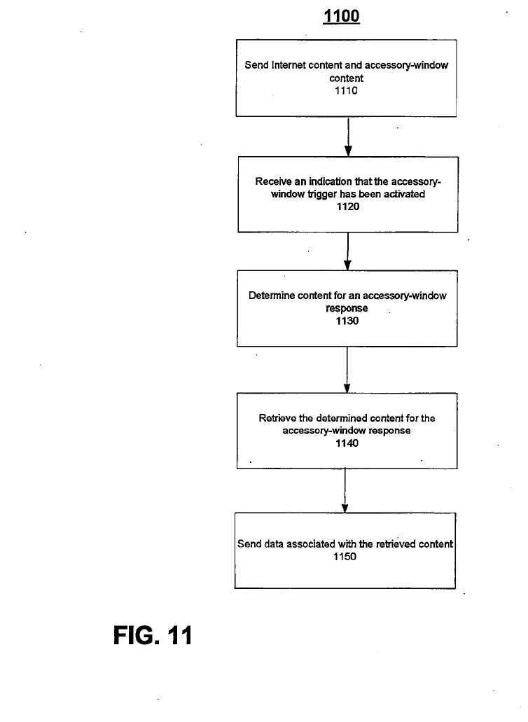

Referring to FIG. 11, a method 1100 for delivering accessory-window content to a client is shown. In the method 1100, a host directs retrieval of Internet content and accessory-window responses at a client. When the client activates a trigger, the host determines the response.

The method begins when the host sends Internet content and accessory-window content (1110). The accessory-window content may be configured to enable the client to render the accessory-window concurrent with a window used to display the Internet content. The accessory-window content may also be configured to enable monitoring of user activity outside of the rendered accessory-window for specific activities or situations by a process related to the accessory-window, to activate an accessory-window trigger in response to detecting one or more of the specific activities or situations, and to send to the host an indication that the accessory-window trigger has been activated.

The host receives an indication that the accessory-window trigger has been activated (1120). The host determine content for an accessory-window response (1130), and retrieve the determined content for the accessory-window response (1140). The host sends data associated with the retrieved content (1150) to the client.

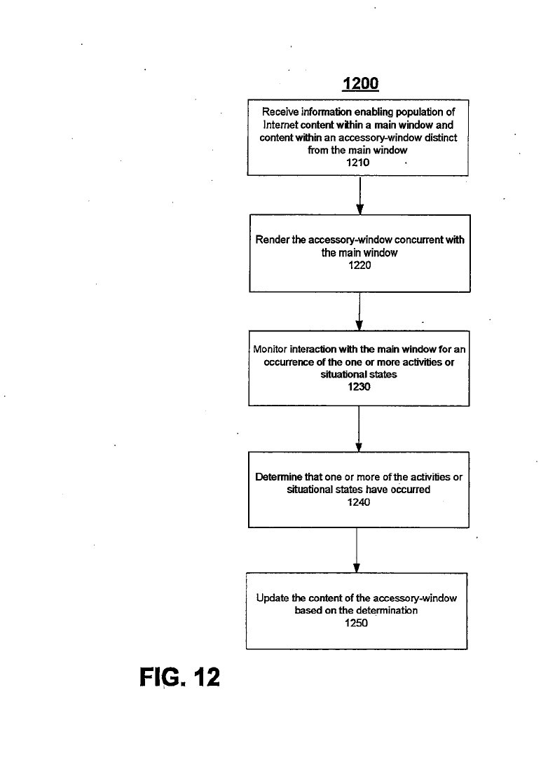

Referring to FIG. 12, a method 1200 for effecting an accessory-window with a main window is shown. In the method 1200, a client receives Internet content and accessory-window content at a client. When the client activates a trigger the accessory-window content is updated.

The method begins when the client receives information enabling population of Internet content within a main window and content within an accessory-window distinct from the main window (1210). In various implementations, the information enabling population of the Internet content and the accessory-window content are received separately. For example, information enabling population of the accessory-window content may be received and rendered within a main window prior to the receipt of the information enabling population of content within an accessory-window. The information enabling population of the accessory-window may include information enabling rendering of the accessory-window concurrent to the main window, information enabling monitoring by a process related to the accessory-window of interaction with the main window for an occurrence of one or more predetermined activities or situational states, and information enabling an addition, update, or deletion to content within the accessory-window.

The client renders the accessory-window concurrent with the main window (1220). The client monitors interaction with the main window for an occurrence of the one or more activities or situational states (1230). The client determines that one or more of the activities or situational states have occurred (1240), and updates the content of the accessory-window based on the determination (1250).

A number of implementations have been described. Nevertheless, it will be understood that various modifications may be made. Furthermore, useful results still could be achieved if steps of the disclosed techniques were performed in a different order and/or if components in the disclosed systems were combined in a different manner and/or replaced or supplemented by other components. Accordingly, implementations other than those specifically described are within the scope of the following claims.

What is claimed is:

1. A method of effecting an accessory-window with a main window, the method comprising:
receiving, from a host, information enabling population of Internet content within a main window;
rendering the main window;
receiving, from the host, information enabling population of content within an accessory-window distinct from the main window, the information enabling population of the accessory-window including:
information enabling rendering of the accessory-window concurrent to the main window,
information enabling monitoring, by a process related to the accessory-window, of user interaction with the main window for an occurrence of one or more activities or situational states, and
information enabling an addition, update, or deletion to content within the rendered accessory-window;
rendering the accessory-window concurrent with the main window;
monitoring interaction with the main window for an occurrence of the one or more activities or situations;
determining that one or more of the activities or situational states have occurred; and
based on the determination, adding or updating the content of the rendered accessory-window.

2. The method of claim 1 wherein receiving information enabling monitoring of interaction with the main window for an occurrence of one or more activities or situational states includes receiving information enabling monitoring, while the accessory-window is rendered, of interaction with the main window for an occurrence of one or more activities or situational states.

3. The method of claim 1 wherein receiving information enabling monitoring of interaction with the main window for an occurrence of one or more activities or situational states includes receiving information enabling monitoring, while the accessory-window is not rendered, of interaction with the main window for an occurrence of one or more activities or situational states.

4. The method of claim 1 wherein receiving information enabling an addition, update, or deletion to content within the accessory-window includes receiving information enabling initial population of the accessory-window.

5. The method of claim 1 wherein receiving information enabling an addition, update, or deletion to content within the accessory-window includes receiving information enabling an addition of content to an existing populated accessory-window.

6. The method of claim 1 wherein receiving information enabling an addition, update, or deletion to content within the accessory-window includes receiving information enabling an update of content within an existing populated accessory-window.

7. The method of claim 1 wherein receiving information enabling an addition, update, or deletion to content within the accessory-window includes receiving information enabling a deletion of content within an existing populated accessory-window.

8. The method of claim 1 wherein receiving information enabling an addition, update, or deletion to content within the accessory-window includes receiving information enabling a closing of an existing populated accessory-window.

9. The method of claim 1 wherein rendering the accessory-window concurrent with the main window includes rendering the accessory-window on a portion of a graphical user interface (GUI) that is distinct from the portion of the GUI used to render the main window.

10. The method of claim 1 wherein rendering the accessory-window concurrent with the main window includes rendering the accessory-window using a process that is distinct from the process used to render the main window.

11. The method of claim 1 wherein rendering the accessory-window concurrent with the main window includes rendering the accessory-window on a portion of the GUI that is within the portion of the GUI used to render the main window.

12. The method of claim 1 wherein rendering the accessory-window concurrent with the main window includes rendering the accessory-window with a position on a GUI that is maintained constant relative to a position on the GUI of the main window.

13. The method of claim 12 wherein rendering the accessory-window with the position on the GUI that is maintained constant relative to a position of the main window includes enabling movement of the main window to effect the position of the accessory-window such that the accessory-window maintains the constant relative position.

14. The method of claim 13 wherein enabling movement of the main window to effect the position of the accessory-window such that the accessory-window maintains the constant relative position includes associating one or more specific pixels of the main window with the accessory-window.

15. The method of claim 1 wherein receiving information enabling population of content within an accessory-window distinct from the main window includes receiving a ready-to-run file of executable code configured to enable rendering of the accessory-window and sending of the indication that the accessory-window trigger has been activated.

16. The method of claim 1 wherein:
receiving information enabling population of Internet content within a main window includes receiving information from a first server configured to send requested Internet content to a plurality of clients; and
receiving information enabling population of content within an accessory-window distinct from the main window includes receiving information from a second server configured to send accessory-window and receive indications that accessory-window triggers have been activated from a plurality of clients.

17. The method of claim 1 further comprising sending an indication to the host that the accessory-window trigger has been activated.

18. The method of claim 17 further comprising receiving, from the host and responsive to communication that the indication that the accessory-window trigger has been activated, data enabling the addition, removal, or change of content within the accessory-window.

19. The method of claim 1 wherein monitoring interaction with the main window includes monitoring a user's activity.

20. The method of claim 19 wherein monitoring a user's activity includes monitoring for interaction with one of several elements displayed within the main window.

21. The method of claim 19 wherein monitoring a user's activity includes monitoring for a lack of interaction with one of several elements displayed within the main window.

22. The method of claim 19 wherein monitoring a user's activity includes monitoring for a number of interactions with one of several elements displayed within the main window.

23. The method of claim 19 wherein monitoring a user's activity includes monitoring for a frequency of interactions with one of several elements displayed within the main window.

24. The method of claim 1 wherein updating the content of the rendered accessory-window includes rendering interactive content enabling user input.

25. The method of claim 1 wherein updating the content of the rendered accessory-window includes changing the shape, size, or location of the accessory-window.

26. A system for effecting an accessory-window with a main window, the system comprising:
a communications module configured to:
receive, from a host, information enabling population of Internet content within a main window, and
receive, from the host, information enabling population of content within an accessory-window distinct from the main window, the information enabling population of the accessory-window including:
information enabling rendering of the accessory-window concurrent to the main window,
information enabling monitoring, by a process related to the accessory-window, of user interaction with the main window for an occurrence of one or more activities or situational states, and
information enabling an addition, update, or deletion to content within the rendered accessory-window;
a main window module configured to render the main window; and
an accessory-window module configured to:
render the accessory-window concurrent with the main window,
monitor interaction with the main window for an occurrence of the one or more activities or situations,
determine that one or more of the activities or situational states have occurred, and
based on the determination, add or update the content of the rendered accessory-window.

27. A system for effecting an accessory-window with a main window, the system comprising:
a communications module configured to:
receive, from a host, information enabling population of Internet content within a main window, and
receive, from the host, information enabling population of content within an accessory-window distinct from the main window, the information enabling population of the accessory-window including:
means for enabling rendering of the accessory-window concurrent to 10 the main window,
means for enabling monitoring, by a process related to the accessory-window, of user interaction with the main window for an occurrence of one or more activities or situational states, and
means for enabling an addition, update, or deletion to content within the accessory-window;
a main window module configured to render the main window; and
an accessory-window module configured to enable:
rendering the accessory-window concurrent with the main window,
means for monitoring interaction with the main window for an occurrence of the one or more activities or situational states,
means for determining that one or more of the activities or situational states have occurred, and
means for, based on the determination, adding or updating the content of the rendered accessory-window.

28. A method of delivering accessory-window content to a client, the method comprising:
sending, to a client, Internet content and accessory-window content, where the accessory-window content is configured to enable:
rendering of the accessory-window concurrent with a window used to display the Internet content,
monitoring, by a process related to the accessory-window, user activity outside of the rendered accessory-window for specific activities or situations,
activating, in response to detecting one or more of the specific activities or situations, an accessory-window trigger, and
sending, to the host, an indication that the accessory-window trigger has been activated;
receiving, from the client, an indication that the accessory-window trigger has been activated;
determining, based on the received indication, content for an accessory-window response;
retrieving the determined content for the accessory-window response; and
sending, to the client, data associated with the retrieved content, the data enabling the client to add, remove, or change content within the rendered accessory-window.

29. The method of claim 28 wherein sending accessory-window content includes sending accessory-window content configured to enable the accessory-window to be rendered upon receipt by the client and from the host of data that is associated with the retrieved content.

30. The method of claim 28 wherein sending accessory-window content includes sending accessory-window content configured to enable a process to run at the client before the accessory-window is rendered, wherein the process is configured to monitor user activity outside of the rendered accessory-window for specific activities or situations.

31. The method of claim 28 wherein sending accessory-window content includes sending accessory-window content configured to enable the accessory-window to be rendered before the monitoring of the user activity.

32. The method of claim 28 wherein sending the Internet content and accessory-window content includes sending the Internet content and the accessory-window content separately.

33. The method of claim 32 wherein sending the Internet content and the accessory-window content separately includes sending a ready-to-run file of executable code configured to enable:
rendering of the accessory-window, and
sending, to the host, the indication that the accessory-window trigger has been activated.

34. The method of claim 32 wherein sending the Internet content and the accessory-window content separately includes sending the Internet content from a first server at the host and sending the accessory-window content from a second server at the host, wherein the first server is configured to send requested Internet content to a plurality of clients, and the second server is configured to send accessory-window content and receive indications that accessory-window triggers have been activated from a plurality of clients.

35. The method of claim 28 wherein sending accessory-window content includes sending a request for instructions for accessing locally-available content.

36. The method of claim 28 wherein receiving the indication that the accessory-window trigger has been activated includes receiving a unique identifier which identifies the type of trigger activated or the context of the trigger activation.

37. The method of claim 28 wherein receiving the indication that the accessory-window trigger has been activated includes receiving an indication that user has interacted with a rendered piece of content.

38. The method of claim 37 wherein receiving an indication that the user has interacted with a rendered piece of content includes receiving text input by the user.

39. The method of claim 28 wherein receiving the indication that the accessory-window trigger has been activated includes receiving an indication that the client has activated an accessory-window trigger and receiving an indication of media content that is locally available at the client for use in an addition or change to the rendered content of the accessory-window.

40. The method of claim 28 wherein retrieving the determined content for the accessory-window response includes retrieving media data over the Internet.

41. The method of claim 28 wherein retrieving the determined content for the accessory-window response includes conducting an Internet search with text input by a user.

42. The method of claim 28 wherein retrieving the determined content for the accessory-window response includes determining instructions to enable the client to access locally-available content.

43. The method of claim 28 wherein sending data enabling the client to add, remove, or change content within the rendered accessory-window includes sending data configured to enable the client to monitor for one or more different activities outside of the rendered accessory-window, or for one or more different specific activities or situations.

44. The method of claim 43 wherein sending data enabling the client to add, remove, or change content within the rendered accessory-window includes sending data configured to enable the client to monitor for one or more different specific activities.

45. The method of claim 43 wherein sending data enabling the client to add, remove, or change content within the rendered accessory-window includes sending data configured to enable the client to monitor for one or more different situations.

46. A system for delivering accessory-window content to a client, the system comprising:
a communications module configured to:
send, to a client, Internet content and accessory-window content, where the accessory-window content is configured to enable:
means for rendering of the accessory-window concurrent with a window used to display the Internet content,
means for monitoring, by a process related to the accessory-window, user activity outside of the rendered accessory-window for specific activities or situations,
means for activating, in response to detecting one or more of the specific activities or situations, an accessory-window trigger, and
sending, to the host, an indication that the accessory-window trigger has been activated, and
receive, from the client, an indication that the accessory-window trigger has been activated, and
send, to the client, data associated with the retrieved content, the data including means enabling the client to add, remove, or change content within the rendered accessory-window;
means for determining, based on the received indication, content for an accessory-window response;
means for retrieving the determined content for the accessory-window response.

47. A system for delivering accessory-window content to a client, the system comprising:
a communications module configured to:
send, to a client, Internet content and accessory-window content, where the accessory-window content is configured to enable:
rendering of the accessory-window concurrent with a window used to display the Internet content,
monitoring, by a process related to the accessory-window, user activity outside of the rendered accessory-window for specific activities or situations,
activating, in response to detecting one or more of the specific activities or situations, an accessory-window trigger, and
sending, to the host, an indication that the accessory-window trigger has been activated; and
receive, from the client, an indication that the accessory-window trigger has been activated; and
a processing module configured to:
determine, based on the received indication, content for an accessory-window response;
retrieve the determined content for the accessory-window response; and
send, to the client, data associated with the retrieved content, the data enabling the client to add, remove, or change content within the rendered accessory-window.
